(19) United States
(12) Patent Application Publication
(10) Pub. No.: US 2025/0351247 A1
(43) Pub. Date: Nov. 13, 2025

(54) DATA OBTAINING DEVICE, DATA OBTAINING METHOD, AND DATA OBTAINING STAGE

(71) Applicant: KYOCERA Corporation, Kyoto-shi, Kyoto (JP)

(72) Inventors: Minami ASATANI, Asaka-shi, Saitama (JP); Kazuhisa ARAKAWA, Yokohama-shi, Kanagawa (JP)

(21) Appl. No.: 18/869,561

(22) PCT Filed: May 18, 2023
(86) PCT No.: PCT/JP2023/018641

§ 371 Date: Nov. 26, 2024

(30) Foreign Application Priority Data
May 31, 2022 (JP) 2022-088690

(51) Int. Cl. H05B 47/105; G06T 7/90

(52) U.S. Cl. CPC H05B 47/105; G06T 7/90; G06T 2207/10024

(57) ABSTRACT

A data obtaining device includes a controller capable of controlling an illumination panel and capable of obtaining at least one captured image, which is obtained by capturing at least one image of an illumination surface of the illumination panel. The controller generates mask data for a target located in front of the illumination panel on a basis of, among the at least one captured image, a captured image of the illumination panel and a target with the illumination panel emitting light.

### CROSS-REFERENCE TO RELATED APPLICATIONS

The present application claims priority to Japanese Patent Application No. 2022-88690 filed in the Japan Patent Office on May 31, 2022, the entire contents of which are incorporated herein by reference.

### TECHNICAL FIELD

The present disclosure relates to a data obtaining device, a data obtaining method, and a data obtaining stage.

### BACKGROUND OF INVENTION

Systems that generate learning data to be used for learning in semantic segmentation or the like are known (e.g., see Patent Literature 1).

### CITATION LIST

### Patent Literature

Patent Literature 1: Japanese Unexamined Patent Application Publication No. 2020-102041

### SUMMARY

In an embodiment of the present disclosure, a data obtaining device includes a controller capable of controlling an illumination panel and capable of obtaining a captured image of the illumination panel and a target located in front of the illumination panel. The controller causes the illumination panel to emit light and generates mask data for the target on a basis of the captured image.

In an embodiment of the present disclosure, a data obtaining method includes causing an illumination panel to emit light and generating mask data for a target located in front of the illumination panel on a basis of a captured image of the target and the illumination panel.

In an embodiment of the present disclosure, a data obtaining stage includes an illumination panel that emits light in certain colors and a light transmission member located between a target disposed in front of the illumination panel and the illumination panel.

### BRIEF DESCRIPTION OF THE DRAWINGS

FIG. 1 is a block diagram illustrating an example of configuration of a data obtaining system according to an embodiment.

FIG. 2 is a plan view illustrating an example of the configuration of the data obtaining system.

FIG. 3 is a cross-sectional view taken along A-A in FIG. 2.

FIG. 4A is a diagram illustrating an example of luminance of each of pixels of a captured image of a target.

FIG. 4B is a diagram illustrating an example of a mask image generated on the basis of the captured image in FIG. 4A.

FIG. 5 is a plan view illustrating an example of a target located on an illumination panel.

FIG. 6A is a diagram illustrating an example of a captured image of the illumination panel emitting light.

FIG. 6B is a diagram illustrating an example of a captured image of a target located on the illumination panel emitting light.

FIG. 6C is a diagram illustrating an example of a mask image generated on the basis of a difference between the captured image in FIG. 6A and the captured image in FIG. 6B.

FIG. 7A is a diagram illustrating an example of a captured image of the target located on the illumination panel that has been turned off.

FIG. 7B is a diagram illustrating the same example of the mask image as in FIG. 6C.

FIG. 7C is a diagram illustrating an example of an extracted image obtained by extracting an image of the target while applying the mask image in FIG. 7B to the captured image in FIG. 7A.

FIG. 8 is a diagram illustrating an example of training data generated by superimposing the extracted image in FIG. 7C upon a background image.

FIG. 9 is a flowchart illustrating an example of a procedure of a data obtaining method.

FIG. 10 is a plan view illustrating an example of a target including side surfaces and located on the illumination panel.

FIG. 11A is a plan view illustrating an example of a case where a color of light emitted from the illumination panel and a color of the side surfaces of the target are the same.

FIG. 11B is a plan view illustrating an example of a case where the color of light emitted from the illumination panel and the color of the side surfaces of the target are different from each other.

FIG. 12A is a diagram illustrating an example of a mask image generated when the color of light emitted from the illumination panel and the color of the side surfaces of the target are the same.

FIG. 12B is a diagram illustrating an example of a mask image generated when the color of light emitted from the illumination panel and the color of the side surfaces of the target are different from each other.

FIG. 12C is a diagram illustrating an example of a mask image generated by calculating a logical sum of each pixel in FIG. 12A and each pixel in FIG. 12B.

FIG. 13 is a flowchart illustrating an example of a procedure of a data obtaining method including a procedure for causing the illumination panel to emit light in at least two colors.

FIG. 14 is a schematic diagram illustrating an example of configuration of a robot control system.

### DESCRIPTION OF EMBODIMENTS

### (Example of Configuration of Data Obtaining System 1)

In an embodiment of the present disclosure, a data obtaining system 1 obtains training data for generating a trained model that outputs a result of recognition of a recognition target included in input information. The trained model may include a CNN (convolution neural network) including a plurality of layers. Convolution based on a certain weighting coefficient is performed on the information input to the trained model in each layer of the CNN. In the training of the trained model, the weighting coefficient is updated. The trained model may include a fully connected layer. The trained model may be VGG16 or ResNet50. The trained model may be a transformer. The trained model is not limited to these examples, and may be a model of one of various other types, instead.

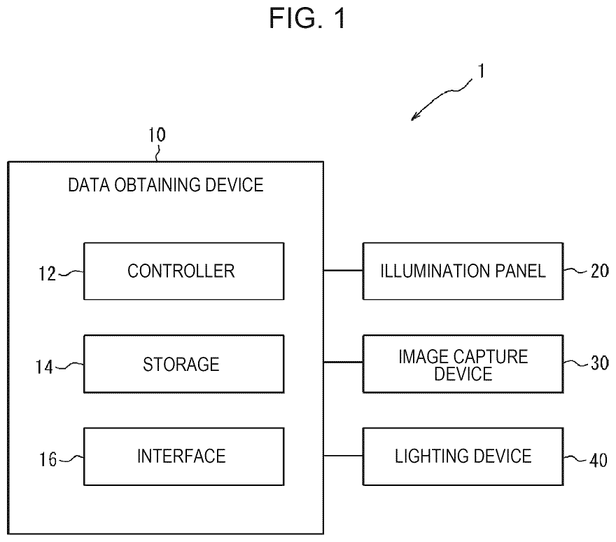

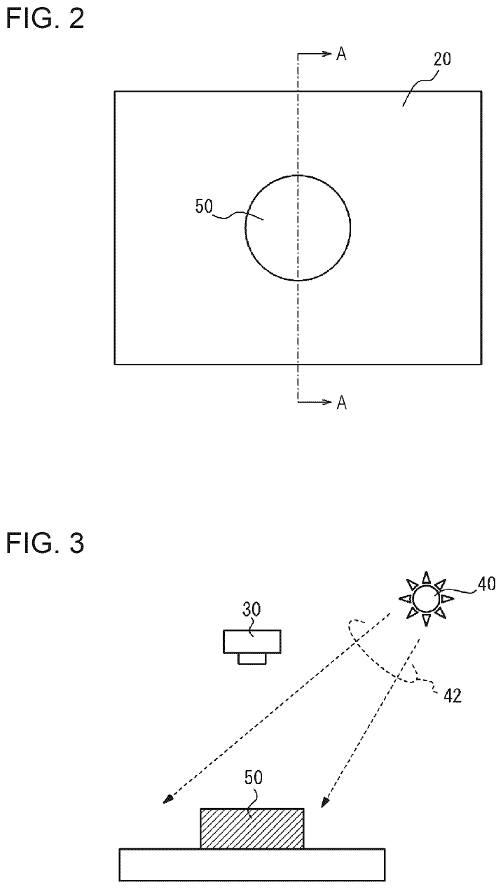

As illustrated in FIGS. 1, 2 and 3, in the embodiment of the present disclosure, the data obtaining system 1 includes a data obtaining device 10, an illumination panel 20, and an image capture device 30. The illumination panel 20 includes an illumination surface, and a target 50 from which training data is to be obtained can be disposed on the illumination surface. The image capture device 30 captures an image of the target 50 disposed on the illumination panel 20 and the illumination panel 20. The image capture device 30 may capture an image of the illumination panel 20 without the target 50 disposed on the illumination panel 20. The data obtaining device 10 controls an illumination state of the illumination panel 20. The data obtaining device 10 obtains an image of the target 50 captured by the image capture device 30. The image of the illumination panel 20 and the target 50 or the image of the illumination panel 20 will also be referred to as a captured image. The data obtaining device 10 is capable of obtaining a captured image. The data obtaining device 10 can generate, for example, data with which the target 50 can be recognized on the basis of a captured image. The data obtaining device 10 can generate and obtain, for example, training data for the target 50 on the basis of a captured image.

### <Data Obtaining Device 10>

The data obtaining device 10 includes a controller 12, a storage 14, and an interface 16.

The controller 12 is capable of controlling the illumination panel 20 and capable of obtaining at least one captured image of the illumination surface of the illumination panel 20. The controller 12 may include at least one processor in order to provide control and processing performance for executing various functions. The processor may execute a program for achieving the various functions of the controller 12. The processor may be achieved as a single integrated circuit. The integrated circuit will also be referred to as an IC. The processor may be achieved as a plurality of integrated circuits and discrete circuits communicably connected to one another. The processor may be achieved on the basis of one of various other known techniques.

The storage 14 may include an electromagnetic storage medium such as a magnetic disk or may include a memory such as a semiconductor memory or a magnetic memory. The storage 14 stores various types of information. The storage 14 stores programs and the like to be executed by the controller 12. The storage 14 may be a non-transitory readable medium. The storage 14 may function as a work memory of the controller 12. At least a part of the storage 14 may be separately configured from the controller 12.

The interface 16 inputs and outputs information or data between the illumination panel 20 and the image capture device 30. The interface 16 may include a communication device capable of wired or wireless communication. The communication device may be capable of performing communication using a communication method based on one of various communication standards. The interface 16 may be achieved by a known communication technique.

The interface 16 may include a display device. The display device may include one of various displays including, for example, a liquid crystal display. The interface 16 may include a sound output device such as a speaker. The interface 16 is not limited to these, and may include one of various other output devices.

The interface 16 may include an input device that receives an input from a user. The input device may include, for example, a keyboard or physical keys or may include a touch panel or a pointing device such as a touch sensor or a mouse. The input device is not limited to these examples, and may include one of various other devices.

### <Illumination Panel 20>

The illumination panel 20 includes the illumination surface. The illumination panel 20 may be a diffuser that diffuses light emitted from a light source and that emits the diffused light in a plane shape. The illumination panel 20 may be a panel that spontaneously emits light. The illumination panel 20 may emit light in one of certain colors. The illumination panel 20 may emit light, for example, in a single color such as white. The illumination panel 20 may emit light in various colors other than white. The illumination panel 20 may emit light in a certain color. The illumination panel 20 may emit light in at least two colors. The illumination panel 20 may control a spectrum of color of emitted light on the basis of a combination of luminance values of, for example, RGB (red, green, and blue).

The illumination panel 20 may include a plurality of pixels. The illumination panel 20 may be capable of setting a state of each pixel to an ON state or an OFF state. The illumination panel 20 may be capable of controlling a color of light emitted from each pixel. The illumination panel 20 may control a color or a pattern of light emitted from the entirety of the illumination panel 20 on the basis of a combination of the states of the pixels or the colors of light emitted from the pixels.

### <Image Capture Device 30 and Lighting Device 40>

The image capture device 30 may include one of various imaging elements, cameras, or the like. The image capture device 30 is disposed in such a way as to be able to capture an image of the illumination surface of the illumination panel 20 and the target 50 disposed on the illumination surface. That is, the image capture device 30 is capable of capturing an image of, along with the illumination panel 20, the target 50 located in front of the illumination panel 20 when viewed from the image capture device 30. The image capture device 30 may be capable of capturing images of the illumination surface of the illumination panel 20 from various directions. The image capture device 30 may be disposed such that a normal direction of the illumination surface of the illumination panel 20 and an optical axis of the image capture device 30 match.

The data obtaining system 1 may also include a darkroom storing the illumination panel 20 and the image capture device 30. When the illumination panel 20 and the image capture device 30 are stored in a darkroom, a side of the target 50 facing the image capture device 30 is not irradiated with ambient light. When the side of the target 50 facing the image capture device 30 is not irradiated with ambient light, the image capture device 30 obtains an image of a silhouette of the target 50 as a captured image by capturing an image of the target 50 using the light emitted from the illumination panel 20 as a background.

The data obtaining system 1 may also include a lighting device 40, which is not essential. As illustrated in FIG. 3, the lighting device 40 emits illumination light 42 that illuminates the target 50. The lighting device 40 may be capable of emitting the illumination light 42 in one of various colors. When the data obtaining system 1 includes the lighting device 40, the image capture device 30 may capture an image of the target 50 with the target 50 illuminated by the illumination light 42 and ambient light. When the data obtaining system 1 includes the lighting device 40 and the darkroom, the image capture device 30 may capture an image of the target 50 with the target 50 illuminated by the illumination light 42.

When the data obtaining system 1 does not include the lighting device 40, the image capture device 30 may capture an image of the target 50 with the target 50 illuminated by ambient light.

### (Example of Operation of Data Obtaining System 1)

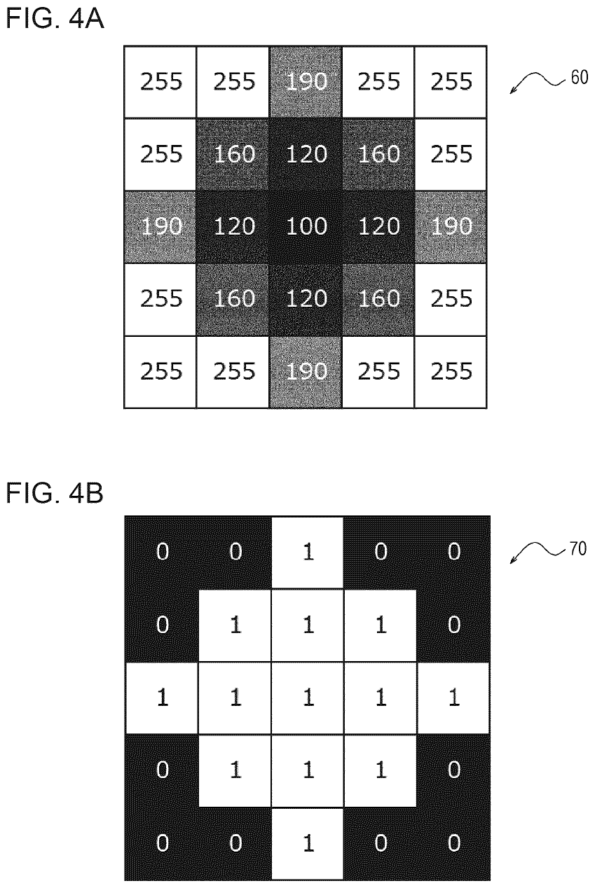

In the data obtaining system 1, the data obtaining device 10 obtains training data to be used in learning for generating a trained model for recognizing the target 50 from an image of the target 50. The image of the target 50 includes a background of the target 50. As illustrated in FIG. 4A, for example, the controller 12 of the data obtaining device 10 may obtain training data from a captured image 60 including 25 pixels arranged in a 5-by-5 matrix. A value in a cell corresponding to each pixel of the captured image 60 corresponds to luminance of the pixel at a time when a color of the pixel is expressed in grayscale. The value indicates luminance in 256 steps of 0 to 255. The larger the value, the whiter the pixel. When the value is 0, the color of the pixel corresponding to the cell is black. When the value is 255, the color of the pixel corresponding to the cell is white.

In FIG. 4A, pixels corresponding to 12 cells whose values are 255 are a background. Pixels corresponding to 13 cells whose values are 190, 160, 120, or 100 are pixels showing the target 50. The controller 12 may generate a mask image 70 as illustrated in FIG. 4B in order to extract the image of the target 50 from the captured image 60. A value in each of cells of the mask image 70 indicates a distinction between a mask section and a transmission section. Pixels corresponding to cells whose values are 1 correspond to a transmission section. The transmission section corresponds to pixels extracted from the captured image 60 as the image of the target 50 when the mask image 70 is superimposed upon the captured image 60. Pixels corresponding to cells whose values are 0 correspond to the mask section. The mask section corresponds to pixels that are not extracted from the captured image 60 when the mask image 70 is superimposed upon the captured image 60.

In a comparative example, whether each pixel of a captured image is a pixel showing a target or a pixel showing a background is determined on the basis of luminance of the pixel. If the luminance of each pixel of the captured image is higher than or equal to a threshold in this case, the pixel is determined as a pixel showing the background. If the luminance of each pixel of the captured image is lower than the threshold, the pixel is determined as a pixel showing the target. In the comparative example, when the background is close to black, a pixel showing the target and a pixel showing the background are difficult to distinguish from each other. Even when each pixel is determined to be showing the background on the basis of a low luminance of the pixel, a pixel showing the target and a pixel showing the background are difficult to distinguish from each other if luminance of pixels showing the background and luminance of pixels showing the target are close to each other. As a result, a transmission section of a mask image is unlikely to match a shape of an image of a target. That is, accuracy of extracting an image of a target is low.

In the present embodiment, therefore, the data obtaining system 1 causes the image capture device 30 to capture an image using the light emitted from the illumination panel 20 as a background of the target 50. In doing so, the background and the target 50 can be easily distinguished from each other. As a result, a transmission section of the mask image 70 used to extract the image of the target 50 tends to match a shape of the image of the target 50. That is, accuracy of extracting the image of the target 50 increases.

A specific example of the operation of the data obtaining system 1 will be described hereinafter.

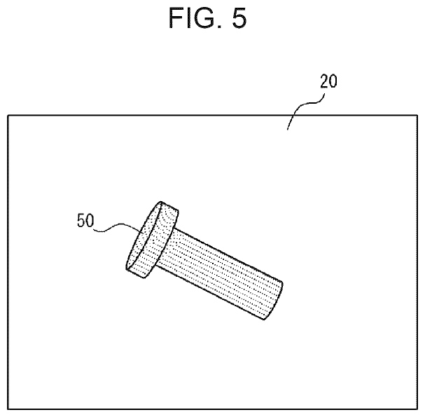

The controller 12 of the data obtaining device 10 obtains training data for generating a trained model that recognizes the target 50 disposed on the illumination panel 20 as illustrated in FIG. 5. The target 50 illustrated in FIG. 5 is a bolt-like part. The target 50 is not limited to a bolt and may be one of various other parts, and is not limited to a part and may be one of various other articles, instead.

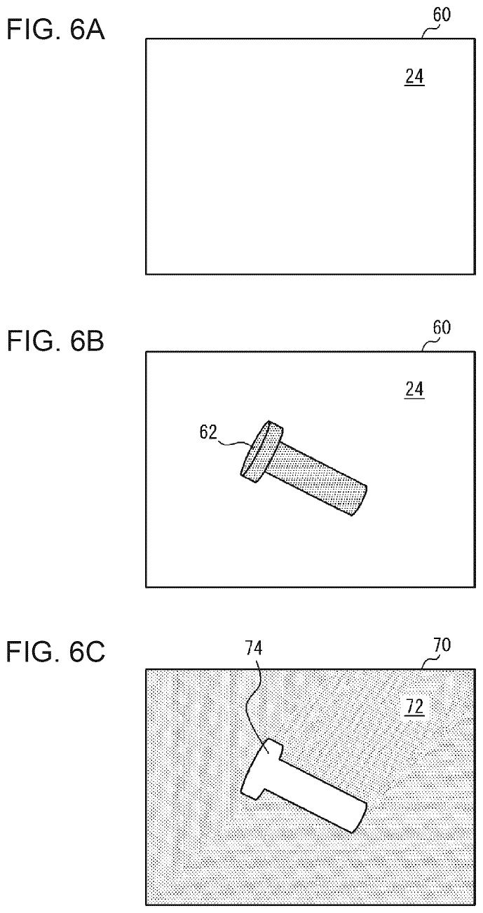

The controller 12 obtains a captured image 60 illustrated in FIG. 6A captured with the illumination panel 20 turned on and without the target 50 disposed on the illumination panel 20. The captured image 60 illustrated in FIG. 6A includes an ON image 24 captured with the illumination panel 20 turned on. The controller 12 obtains a captured image 60 illustrated in FIG. 6B with the illumination panel 20 turned on and the target 50 disposed on the illumination panel 20. The captured image 60 illustrated in FIG. 6B includes a target image 62 of the target 50 as a foreground and the ON image 24 captured with the illumination panel 20 turned on as a background.

The controller 12 generates a mask image 70 as illustrated in FIG. 6C by obtaining a difference between the captured image 60 in FIG. 6A that does not include the target image 62 and the captured image 60 in FIG. 6B including the target image 62. The mask image 70 will also be referred to as mask data. In other words, when the controller 12 has obtained at least one captured image 60, the controller 12 may generate mask data for the target 50 on the basis of, among the at least one captured image 60, the captured image 60 that has been obtained by capturing an image of the illumination panel 20 and the target 50 located in front of the illumination panel 20 with the illumination panel 20 turned on and the captured image 60 that has been obtained by capturing an image of the illumination panel 20 without the target 50 located in front of the illumination panel 20.

The captured image 60 in FIG. 6A that does not include the target image 62 will also be referred to as a background image. The background image may be a captured image 60 of only the illumination panel 20 or a captured image 60 of the illumination panel 20 and some indicator. The image in FIG. 6B including the target image 62 will also be referred to as a foreground image. In this case, the controller 12 can generate mask data on the basis of the foreground image and the background image.

The mask image 70 includes a mask section 72 and a transmission section 74. Accuracy of a shape of the mask section 72 in the mask image 70 can be increased by increasing a contrast between the illumination panel 20 emitting light and the target 50. The controller 12 may control the illumination panel 20 in such a way as to increase the contrast between the illumination panel 20 emitting light and the target 50. The controller 12 may determine the color of light emitted from the illumination panel 20 on the basis of a color of the target 50.

The illumination panel 20 and the image capture device 30 may be stored in a darkroom so that the contrast between the illumination panel 20 emitting light and the target 50 increases. When the illumination panel 20 and the image capture device 30 are stored in a darkroom, the controller 12 can obtain the captured image 60 without the target 50 and the illumination panel 20 illuminated by ambient light.

The controller 12 may control the illumination light 42 of the lighting device 40 in such a way as to increase the contrast between the illumination panel 20 emitting light and the target 50. For example, the controller 12 may set luminance of light emitted from the illumination panel 20 such that luminance of pixels showing the illumination panel 20 in the captured image 60 becomes higher than luminance of pixels showing the target 50.

The image capture device 30 may capture an OFF image with the target 50 disposed on the illumination panel 20 and the illumination panel 20 turned off. The image capture device 30 may capture an ON image with the target 50 disposed on the illumination panel 20 and the illumination panel 20 turned on. The controller 12 may generate a mask image 70 as mask data on the basis of a difference between the OFF image and the ON image. In other words, the controller 12 may generate the mask data for the target 50 also on the basis of a differential image between a captured image 60 at a time when the illumination panel 20 is emitting light and a captured image 60 at a time when the illumination panel 20 is not emitting light.

The controller 12 generate the mask data only on the basis of the foreground image. For example, the controller 12 may generate the mask data for the target 50 by distinguishing a part of the foreground image showing the illumination panel 20 and a part of the foreground image showing the target 50. That is, when the controller 12 has obtained at least one captured image, the controller 12 may generate the mask data for the target 50 on the basis of, among the at least one captured image, a captured image 60 that has been obtained by capturing an image of the illumination panel 20 and the target 50 located in front of the illumination panel 20 with the illumination panel 20 emitting light.

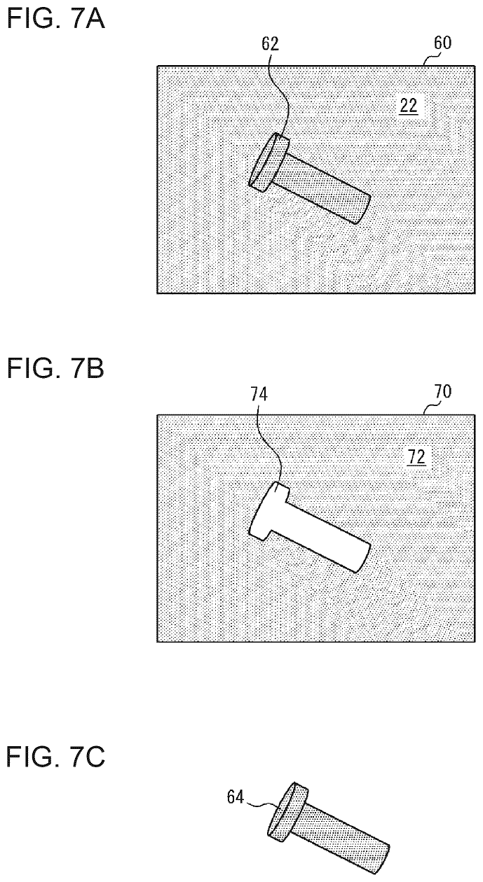

The controller 12 extracts a target image 62 from the captured image 60 using the generated mask image 70 to generate an extracted image 64 (see FIG. 7C). More specifically, the controller 12 obtains the captured image 60 illustrated in FIG. 7A, the captured image 60 being obtained with the illumination panel 20 turned off and the target 50 disposed on the illumination panel 20. The captured image 60 in FIG. 7A includes the target image 62 of the target 50 as a foreground and an OFF image 22 captured with the illumination panel 20 turned off as a background.

The controller 12 may generate the extracted image 64 by extracting image data regarding the target 50 from the captured image 60 used to generate the mask data. The controller 12 may generate the extracted image 64 by extracting, on the basis of the mask data for the target 50, the image data regarding the target 50 from an image of the target 50 captured at the same position as when the captured image 60 has been captured.

The controller 12 generates the extracted image 64 illustrated in FIG. 7C by extracting the target image 62 while applying the mask image 70 illustrated in FIG. 7B to the captured image 60 illustrated in FIG. 7A. The extracted image 64 includes a foreground including pixels showing the target 50 and a background consisting of transparent pixels.

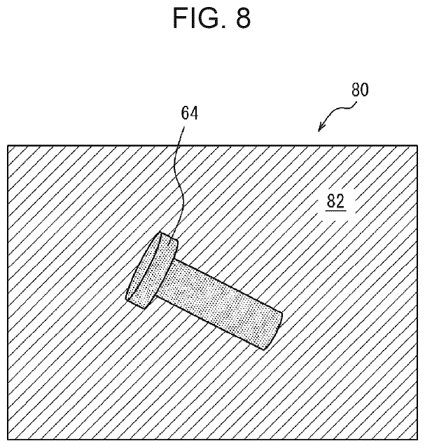

The controller 12 may generate training data using the extracted image 64. More specifically, the controller 12 may generate, as illustrated in FIG. 8, an image obtained by combining together the extracted image 64 and any background image 82 as a composite image 80. The controller 12 may output the composite image 80 as the training data.

When the extracted image 64 is generated, an image of the target 50 may be one captured with the target 50 illuminated by ambient light, instead. When the extracted image 64 is generated, an image of the target 50 may be one captured with the target 50 disposed at a position different from the illumination panel 20, instead.

When the extracted image 64 is generated, the controller 12 may capture an image of the target 50 while controlling the lighting device 40. That is, the controller 12 may capture an image of the target 50 under a lighting environment where a position or luminance of the illumination light 42 is controlled in order to increase diversity of training data. Images of the target 50 may be captured in plurality of lighting environments.

### <Example of Procedure of Data Obtaining Method>

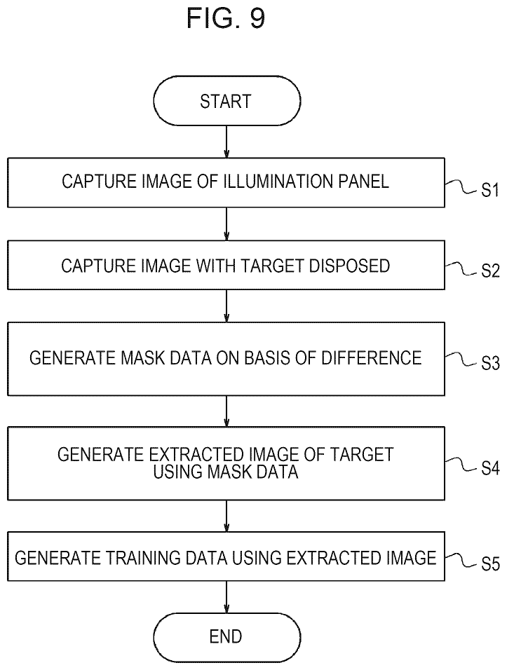

The data obtaining device 10 may perform a data obtaining method including a procedure illustrated in a flowchart of FIG. 9. The data obtaining method may be achieved as a data obtaining program executed by the processor included in the controller 12 of the data obtaining device 10, instead. The data obtaining program may be stored in a non-transitory computer-readable medium.

The controller 12 captures an image of the illumination panel 20 using the image capture device 30 (step S1). More specifically, the controller 12 may capture an image of the illumination panel 20 using the image capture device 30 with the illumination panel 20 turned on and emitting light and without the target 50 disposed on the illumination panel 20. The controller 12 may obtain an image of the illumination panel 20 that has been turned on and that is emitting light.

The controller 12 captures an image of the illumination panel 20 using the image capture device 30 with the target 50 disposed on the illumination panel 20 and the illumination panel 20 turned on and emitting light (step S2). The controller 12 may obtain the images captured by the image capture device 30. The controller 12 generates mask data on the basis of a difference between the image of the illumination panel 20 captured without the target 50 disposed and the image of the illumination panel 20 captured with the target 50 disposed (step S3). More specifically, the controller 12 may generate a mask image 70 as mask data.

The controller 12 generates an extracted image 64 by extracting an image of the target 50 from a captured image 60 using the mask data (step S4). The controller 12 generates training data using the extracted image 64 (step S5). After performing the procedure in step S5, the controller 12 ends the execution of the procedure illustrated in the flowchart of FIG. 9.

### SUMMARY

As described above, with the data obtaining system 1, the data obtaining device 10, and the data obtaining method according to the present embodiment, the contract between the target 50 and the background can be increased in the captured image 60 of the target 50. As a result of the increase in the contrast, mask data for extracting the target 50 can be accurately generated. Since the mask data can be accurately generated, the image of the target 50 need not be manually corrected. As a result, annotations can be simplified.

### Other Embodiments

Other embodiments will be described hereinafter.

### <Effect of Side Surfaces 54 of Target 50>

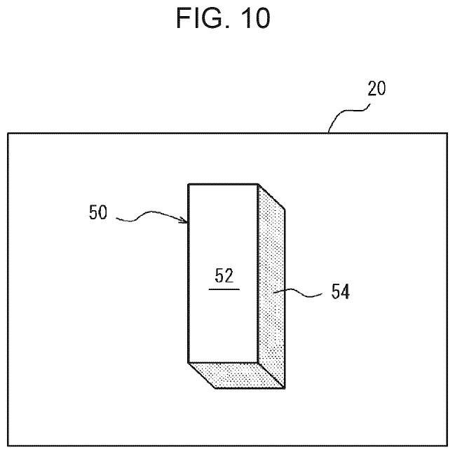

As illustrated in FIG. 10, the target 50 might include an upper surface 52 and side surfaces 54. When the illumination panel 20 is turned on and emits light, the light emitted from the illumination panel 20 can be reflected from the side surfaces 54 and enter the image capture device 30. If the light reflected from the side surfaces 54 enters the image capture device 30, the side surfaces 54 of the target 50 might appear to be emitting light in the captured image 60.

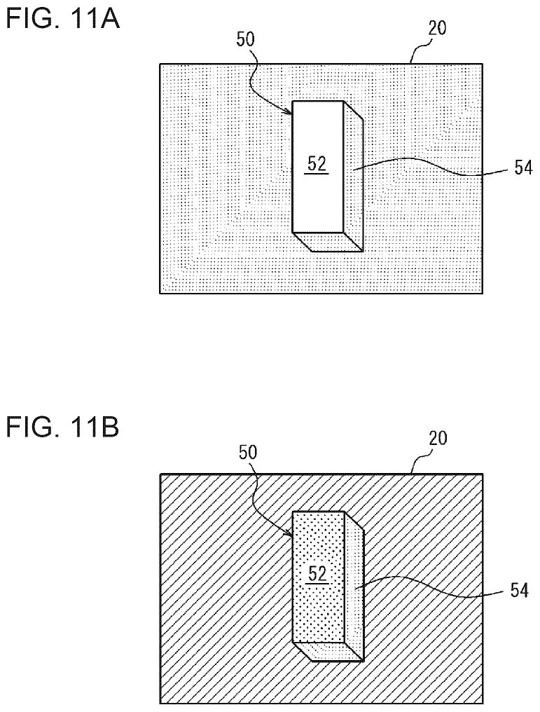

More specifically, as illustrated in FIG. 11A, when the color of light emitted from the illumination panel 20 and a color of the side surfaces 54 of the target 50 are the same or similar to each other, the illumination panel 20 and the side surfaces 54 of the target 50 are difficult to distinguish from each other in the captured image 60. In this case, in the mask image 70, only the upper surface 52 of the target 50 can be set as the transmission section 74, and the side surfaces 54 can be set as the mask section 72.

When the color of light emitted from the illumination panel 20 and the color of the side surfaces 54 of the target 50 are significantly different from each other as illustrated in FIG. 11B, on the other hand, the illumination panel 20 and the side surfaces 54 of the target 50 can be easily distinguished from each other in the captured image 60. When the color of light emitted from the illumination panel 20 and the color of the side surfaces 54 of the target 50 are complementary colors, for example, the illumination panel 20 and the side surfaces 54 of the target 50 can be easily distinguished from each other in the captured image 60. In this case, the upper surface 52 and the side surfaces 54 of the target 50 can be set as the transmission section 74 in the mask image 70.

An effect of light reflected from the side surfaces 54 can thus be reduced by causing the illumination panel 20 to emit light in at least two colors and generating mask data for each color.

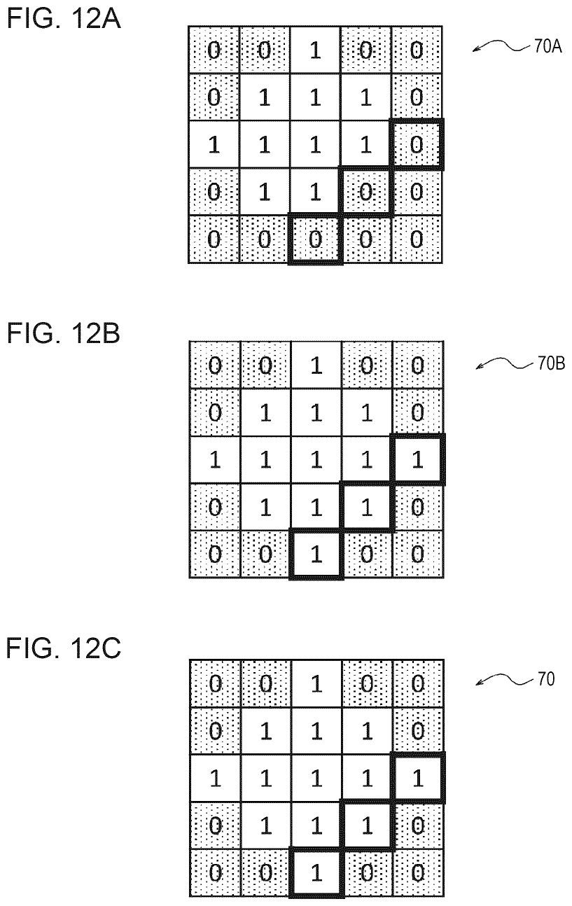

The controller 12 may cause, for example, the illumination panel 20 to emit light in the same color as that of the side surfaces 54 of the target 50 as a first color and cause the illumination panel 20 to emit light in a color different from that of the side surfaces 54 as a second color. The illumination panel 20 illustrated in FIG. 11A is emitting light in the first color. FIG. 12A illustrates an image of mask data generated on the basis of an image of the illumination panel 20 illustrated in FIG. 11A. The image of the mask data illustrated in FIG. 12A is an image at a time when the illumination panel 20 is emitting light in the first color, and will be referred to as a first mask image 70A. The illumination panel 20 illustrated in FIG. 11B is emitting light in the second color. FIG. 12B illustrates an image of mask data generated on the basis of an image of the illumination panel 20 illustrated in FIG. 11B. The image of the mask data illustrated in FIG. 12B is an image at a time when the illumination panel 20 is emitting light in the second color, and will be referred to as a second mask image 70B.

In the first mask image 70A in FIG. 12A and the second mask image 70B in FIG. 12B, cells surrounded by thicker frames than other cells indicate pixels corresponding to the side surfaces 54 of the target 50. The pixels of the first mask image 70A in FIG. 12A corresponding to the side surfaces 54 are the mask section 72. The pixels of the second mask image 70B in FIG. 12B corresponding to the side surfaces 54 are the transmission section 74. That is, whether the pixels corresponding to the side surfaces 54 are the mask section 72 or the transmission section 74 depends on whether the illumination panel 20 is emitting light in the first color or the second color.

The controller 12 may generate the mask image 70 by calculating a logical sum of the first mask image 70A in FIG. 12A and the second mask image 70B in FIG. 12B. More specifically, the controller 12 can generate the mask image 70 illustrated in FIG. 12C by calculating a logical sum of each pixel of the first mask image 70A and each pixel of the second mask image 70B. In other words, the controller 12 may generate the mask data for the target 50 using a plurality of pieces of mask data corresponding to a plurality of colors of light emitted from the illumination panel 20 based on captured images 60 at times when the illumination panel 20 is emitting light in the plurality of colors. In a mask image 70 in FIG. 12C, pixels corresponding to the side surfaces 54 of the target 50 are the transmission section 74. When only the first mask image 70A is generated, mask data corresponding to the side surfaces 54 of the target 50 is incorrect data. An error in the mask data corresponding to the side surfaces 54 of the target 50 hardly occurs when the illumination panel 20 is caused to emit light in at least two different colors and mask data is generated for each color.

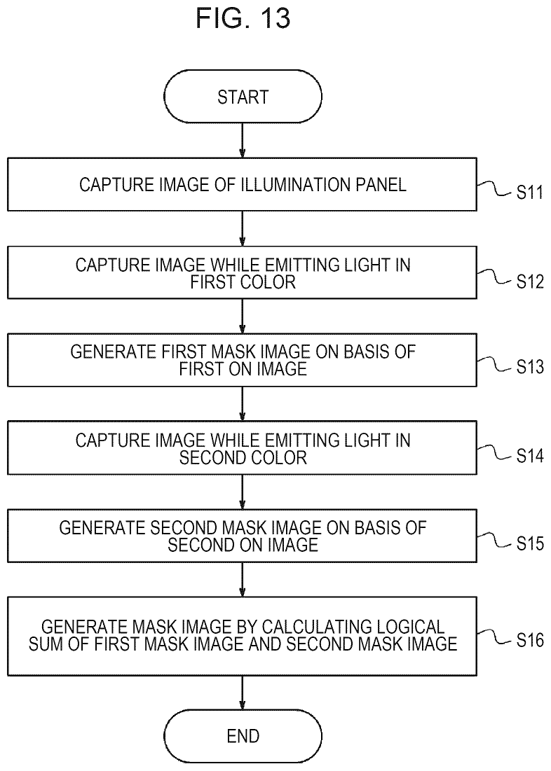

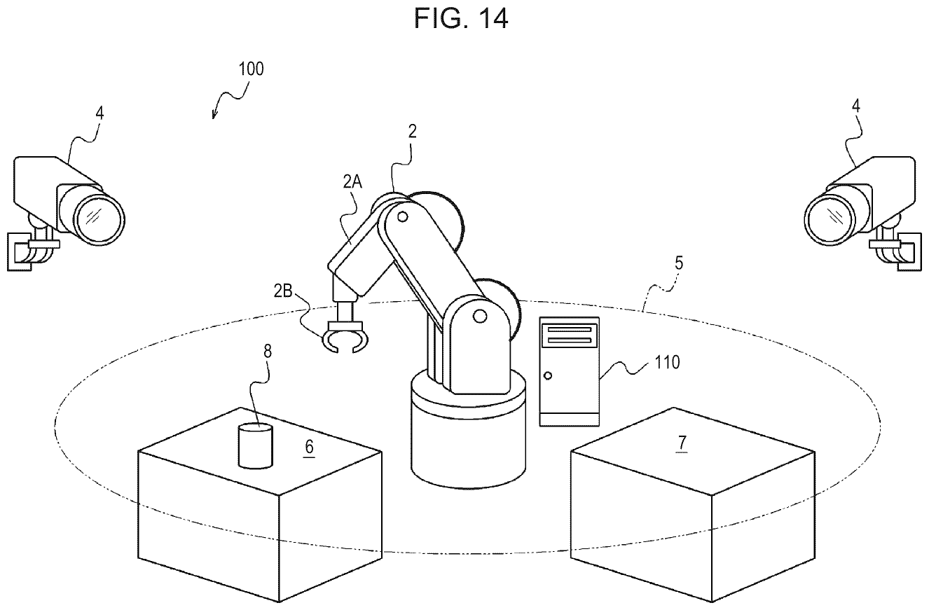

The data obtaining device 10 may perform a data obtaining method including a procedure for turning on the illumination panel 20 in a plurality of colors as illustrated in a flowchart of FIG. 13. The data obtaining method may be achieved as a data obtaining program executed by the processor included in the controller 12 of the data obtaining device 10, instead. The data obtaining program may be stored in a non-transitory computer-readable medium.

The controller 12 captures an image of the illumination panel 20 using the image capture device 30 (step S11). More specifically, the controller 12 may turn on the illumination panel 20 to cause the illumination panel 20 to emit light in the first color and the second color, and capture images of the illumination panel 20 using the image capture device 30 without the target 50 disposed on the illumination panel 20. The controller 12 may obtain images of the illumination panel 20 that has been turned on and that is emitting light in the first color and the second color, respectively.

The controller 12 captures an image of the illumination panel 20 using the image capture device 30 with the target 50 disposed on the illumination panel 20 and the illumination panel 20 turned on and emitting light in the first color (step S12). The controller 12 may obtain the image captured by the image capture device 30 as a first ON image. The controller 12 generates a first mask image 70A on the basis of the first ON image (step S13).

The controller 12 captures an image of the illumination panel 20 using the image capture device 30 with the target 50 disposed on the illumination panel 20 and the illumination panel 20 turned on and emitting light in the second color (step S14). The controller 12 may obtain the image captured by the image capture device 30 as a second ON image. The controller 12 generates a second mask image 70B on the basis of the second ON image (step S15).

The controller 12 calculates a logical sum of the first mask image 70A and the second mask image 70B to generate a mask image 70 (step S16). More specifically, the controller 12 calculates a logical sum of each pixel of the first mask image 70A and each pixel of the second mask image 70B and generates, as the mask image 70, an image where results of the calculation of the pixels are arranged. After performing the procedure in step S16, the controller 12 ends the execution of the procedure illustrated in the flowchart of FIG. 13.

### <Data Obtaining Stage>

The data obtaining system 1 may include a data obtaining stage for obtaining data. The data obtaining stage may include the illumination panel 20 and a plate for disposing the target 50 on the illumination surface of the illumination panel 20. The plate for disposing the target 50 transmits light emitted from the illumination panel 20, and will also be referred to as a light transmission member. The light transmission member may be configured such that the target 50 does not directly come into contact with the illumination surface. The light transmission member may be provided away from the illumination surface or may be provided on the illumination surface.

The data obtaining stage may also include a darkroom for storing the illumination panel 20 and the light transmission member. The data obtaining stage may also include the lighting device 40 capable of illuminating the target 50.

### (Example of Configuration of Robot Control System 100)

As illustrated in FIG. 14, in an embodiment, the robot control system 100 includes a robot 2 and a robot control device 110. In the present embodiment, the robot 2 moves a workpiece 8 from a work start point 6 to a work target point 7. That is, the robot control device 110 controls the robot 2 in such a way as to move the workpiece 8 from the work start point 6 to the work target point 7. The workpiece 8 will also be referred to as a work target. The robot control device 110 controls the robot 2 on the basis of information regarding a space where the robot 2 works. The information regarding the space will also be referred to as spatial information.

### <Robot Control Device 110>

The robot control device 110 obtains a trained model based on learning using training data generated by the data obtaining device 10. The robot control device 110 recognizes, on the basis of images captured by cameras 4 and the trained model, the workpiece 8, or the work start point 6 or the work target point 7, in the space where the robot 2 works. In other words, the robot control device 110 obtains a trained model generated in order to recognize the workpiece 8 or the like on the basis of images captured by the cameras 4.

The robot control device 110 may include at least one processor in order to provide control and processing performance for executing various functions. The components of the robot control device 110 may include at least one processor. Some of the components of the robot control device 110 may be achieved by one processor. The entirety of the robot control device 110 may be achieved by one processor. The processor may execute a program for achieving the various functions of the robot control device 110. The processor may be achieved as a single integrated circuit. The integrated circuit will also be referred to as an IC. The processor may be achieved as a plurality of integrated circuits and discrete circuits communicably connected to one another. The processor may be achieved on the basis of one of various other known techniques.

The robot control device 110 may include a storage. The storage may include an electromagnetic storage medium such as a magnetic disk or may include a memory such as a semiconductor memory or a magnetic memory. The storage stores various types of information and programs and the like to be executed by the robot control device 110. The storage may be a non-transitory readable medium. The storage may function as a work memory of the robot control device 110. At least a part of the storage may be separately configured from the robot control device 110.

### <Robot 2>

The robot 2 may include an arm 2A and an end effector 2B. The arm 2A may be, for example, a six-axis or seven-axis vertical articulated robot. The arm 2A may be a three-axis or four-axis horizontal articulated robot or SCARA robot, instead. The arm 2A may be a two-axis or three-axis Cartesian robot, instead. The arm 2A may be a parallel link robot or the like, instead. The number of axes of the arm 2A is not limited to those described above. In other words, the robot 2 includes the arm 2A connected through a plurality of joints, and moves by driving the joints.

The end effector 2B may include a holding hand capable of holding the workpiece 8. The holding hand may include a plurality of fingers. The number of fingers of the holding hand may be two or more. The fingers of the holding hand may each include one or more joints. The end effector 2B may include a suction hand capable of sucking on the workpiece 8. The end effector 2B may include a scooping hand capable of scooping the workpiece 8. The end effector 2B may include a tool such as a drill, and be capable of drilling a hole in the workpiece 8 and performing various other types of processing. The end effector 2B is not limited to these examples, and may be capable of performing various other operations. In the configuration illustrated in FIG. 14, the end effector 2B includes a holding hand.

The robot control device 110 can control a position of the end effector 2B by operating the arm 2A of the robot 2. The end effector 2B may have an axis that serves as a reference for a direction in which the end effector 2B acts on the workpiece 8. When the end effector 2B has an axis, the robot control device 110 can control a direction of the axis of the end effector 2B by operating the arm 2A of the robot 2. The robot control device 110 controls a start and an end of an operation of the end effector 2B acting on the workpiece 8. The robot control device 110 can move or process the workpiece 8 by controlling the operation of the end effector 2B while controlling the position of the end effector 2B or the direction of the axis of the end effector 2B. In the configuration illustrated in FIG. 14, the robot control device 110 causes the end effector 2B to hold the workpiece 8 at the work start point 6 and moves the end effector 2B to the work target point 7. The robot control device 110 causes the end effector 2B to release the workpiece 8 at the work target point 7. In doing so, the robot control device 110 can move the workpiece 8 from the work start point 6 to the work target point 7 using the robot 2.

### <Sensor 3>

As illustrated in FIG. 14, the robot control system 100 also includes a sensor 3. The sensor 3 detects physical information regarding the robot 2. The physical information regarding the robot 2 may include information regarding an actual position or attitude of each component of the robot 2 or velocity or acceleration of each component of the robot 2. The physical information regarding the robot 2 may include information regarding force acting on each component of the robot 2. The physical information regarding the robot 2 may include information regarding a current flowing to a motor that drives each component of the robot 2 or torque of the motor. The physical information regarding the robot 2 indicates a result of an actual operation of the robot 2. That is, the robot control system 100 can grasp a result of an actual operation of the robot 2 by obtaining the physical information regarding the robot 2.

The sensor 3 may include a force sensor or a tactile sensor that detects force distributed pressure, sliding, or the like acting on the robot 2 as the physical information regarding the robot 2. The sensor 3 may include a motion sensor that detects a position or an attitude, or velocity or acceleration, of the robot 2 as the physical information regarding the robot 2. The sensor 3 may include a current sensor that detects the currents flowing to the motors that drive the robot 2 as the physical information regarding the robot 2. The sensor 3 may include a torque sensor that detects torque of the motors that drive the robot 2 as the physical information regarding the robot 2.

The sensor 3 may be mounted on each joint of the robot 2 or each of joint drivers that drive the joints. The sensor 3 may be mounted on the arm 2A or the end effector 2B of the robot 2.

The sensor 3 outputs the detected physical information regarding the robot 2 to the robot control device 110. The sensor 3 detects and outputs the physical information regarding the robot 2 at certain timing. The sensor 3 outputs the physical information regarding the robot 2 as time-series data.

### <Cameras 4>

In the example of configuration illustrated in FIG. 14, the robot control system 100 includes two cameras 4. The cameras 4 capture images of articles, humans, and the like located inside an effect range 5 in which the operation off the robot 2 can be affected. The images captured by the cameras 4 may include monochromatic luminance information or color luminance information expressed in RGB or the like. The effect range 5 includes an operation range of the robot 2. The effect range 5 is a range obtained by extending the operation range of the robot 2 outward. The effect range 5 may be set such that the robot 2 can be stopped before a human or the like moving from the outside of the operation range of the robot 2 to the inside of the operation range enters the operation range of the robot 2. The effect range 5 may be set as, for example, a range obtained by extending a boundary of the operation range of the robot 2 outward by a certain distance. The cameras 4 may be installed in such a way as to be able to capture images of the effect range 5 or the operation range of the robot 2 or a surrounding area from above. The number of cameras 4 is not limited to two, and may be one, or three or more, instead.

### (Example Operation of Robot Control System 100)

The robot control device 110 obtains a trained model in advance. The robot control device 110 may store the trained model in the storage. The robot control device 110 obtains images of the workpiece 8 from the cameras 4. The robot control device 110 inputs the images of the workpiece 8 to the trained model as input information. The robot control device 110 obtains output information output from the trained model in accordance with the input of the input information. The robot control device 110 recognizes the workpiece 8 on the basis of the output information and performs an operation for holding and moving the workpiece 8.

### SUMMARY

As described above, the robot control system 100 can obtain a trained model based on learning using training data generated by the data obtaining system 1 and recognize the workpiece 8 using the trained model.

Although some embodiments of the data obtaining system 1 and the robot control system 100 have been described above, embodiments of the present disclosure may also include modes of a method or a program for implementing a system or an apparatus and a storage medium (e.g., an optical disc, a magneto-optical disk, a CD-ROM, a CD-R, a CD-RW, a magnetic tape, a hard disk, a memory card, etc.) storing the program.

Implementation modes of the program are not limited to application programs such as object code compiled by a compiler and program code executed by an interpreter, and may be a mode such as a program module incorporated into an operating system, instead. The program may or may not be configured such that a CPU on a control substrate alone performs all processing. The program may be configured such that another processing unit mounted on an expansion board or an expansion unit attached to the substrate performs part or the entirety of the program as necessary.

Although some embodiments of the present disclosure have been described on the basis of the drawings and the examples, note that those skilled in the art can make various variations or alterations on the basis of the present disclosure. Note, therefore, that the scope of the present disclosure includes these variations or alterations. For example, functions included in each component or the like can be rearranged without causing a logical contradiction, and a plurality of components or the like can be combined together or further divided.

All of the components described in the present disclosure and/or all of the disclosed methods or all of the steps in the process may be combined in any manner unless corresponding features are mutually exclusive. Each of the features described in the present disclosure can be replaced by an alternative feature that serves for the same, equivalent, or similar purpose, unless explicitly denied. Each of the disclosed features, therefore, is just an example of a comprehensive series of the same or equivalent features, unless explicitly denied.

The embodiments in the present disclosure are not limited to any specific configuration according to one of the above-described embodiments. The embodiments of the present disclosure can be expanded to all the novel features described in the present disclosure or a combination thereof, all the novel methods or the steps in the process described or a combination thereof.

In the present disclosure, terms such as “first” and “second” are identifiers for distinguishing the corresponding components. The components distinguished with the terms such as “first” and “second” in the present disclosure may exchange the numbers thereof. For example, the first mask image 70A may exchange “first” for “second”, which are identifiers, with the second mask image 70B. The identifiers are simultaneously exchanged. Even after the exchange of the identifiers, the components are still distinguished from each other. Identifiers may be removed. Components from which identifiers have been removed are distinguished from each other by reference numerals. The identifiers such as “first” and “second” in the present disclosure are not intended to be used as a sole basis for interpretation of order of the components or presence of an identifier with a smaller number.

In an embodiment, (1) a data obtaining device includes a controller capable of controlling an illumination panel and capable of obtaining at least one captured image of an illumination surface of the illumination panel. The controller generates mask data for a target located in front of the illumination panel on a basis of, among the at least one captured image, a captured image of the illumination panel and the target with the illumination panel emitting light.

(2) In the data obtaining device according to (1), the controller may determine a color of the light emitted from the illumination panel on a basis of a color of the target.

(3) In the data obtaining device according to (1) or (2), the controller may cause the illumination panel to emit light in a plurality of colors. The controller may generate the mask data for the target using a plurality of pieces of mask data corresponding to the plurality of colors of the light emitted from the illumination panel based on captured images at times when the illumination panel is emitting the light in the plurality of colors.

(4) In the data obtaining device according to any of (1) to (3), the controller may generate the mask data for the target on a basis of, among the at least one captured image, a captured image obtained by capturing an image of the illumination panel without the target located in front of the illumination panel.

(5) In the data obtaining device according to any of (1) to (4), the controller may generate the mask data for the target on a basis of a differential image between a captured image at a time when the illumination panel is emitting light and a captured image at a time when the illumination panel is not emitting light.

(6) In the data obtaining device according to any of (1) to (5), the controller may obtain a captured image without the target and the illumination panel illuminated by ambient light.

(7) In the data obtaining device according to any of (1) to (6), the controller may set luminance of the light emitted from the illumination panel such that luminance of the illumination panel becomes higher than luminance of the target in the at least one captured image.

(8) In the data obtaining device according to any of (1) to (7), the controller may extract, on a basis of the mask data for the target, image data regarding the target from an image of the target captured at a same position as when the at least one captured image has been captured.

(9) In the data obtaining device according to (8), the controller may control illumination light that illuminates the target.

In an embodiment, (10) a data obtaining method includes causing an illumination panel to emit light and generating mask data for a target located in front of the illumination panel on a basis of the target and a captured image of the illumination panel.

(11) The data obtaining method according to (10) may further include extracting, on a basis of the mask data for the target, image data regarding the target from an image of the target at a same position as when the at least one captured image has been captured.

In an embodiment, (12) a data obtaining stage includes an illumination panel that emits light in certain colors and a light transmission member located between a target disposed in front of the illumination panel and the illumination panel.

(13) The data obtaining stage according to (12) may further include a darkroom storing the illumination panel and the light transmission member.

(14) The data obtaining stage according to (12) or (13) may further include a lighting device capable of illuminating the target.

(15) In the data obtaining stage according to any of (12) to (14), the illumination panel may emit light in one of the certain colors.

### REFERENCE SIGNS

1 data obtaining system
10 data obtaining device (12: controller, 14: storage, 16: interface)
20 illumination panel (22: OFF image, 24: ON image)
30 image capture device
40 lighting device (42: illumination light)
50 target (52: upper surface, 54: side surface)
60 captured image (62: target image, 64: extracted image of target)
70 mask image (70A: first mask image, 70B: second mask image, 72: mask
section, 74: transmission section)
80 composite image (82: background image)
100 robot control system (2: robot, 2A: arm, 2B: end effector, 3: sensor, 4: camera,
5: effect range, 6: work start point, 7: work target point, 8: workpiece, 110: robot control device)

1. A data obtaining device comprising:
a controller capable of controlling an illumination panel and capable of obtaining at least one captured image of an illumination surface of the illumination panel,
wherein the controller generates mask data for a target located in front of the illumination panel on a basis of, among the at least one captured image, a captured image of the illumination panel and the target with the illumination panel emitting light.

2. The data obtaining device according to claim 1,
wherein the controller determines a color of the light emitted from the illumination panel on a basis of a color of the target.

3. The data obtaining device according to claim 1,
wherein the controller causes the illumination panel to emit light in a plurality of colors, and
wherein the controller generates the mask data for the target using a plurality of pieces of mask data corresponding to the plurality of colors of the light emitted from the illumination panel based on captured images at times when the illumination panel is emitting the light in the plurality of colors.

4. The data obtaining device according to claim 1,
wherein the controller generates the mask data for the target on a basis of, among the at least one captured image, a captured image obtained by capturing an image of the illumination panel without the target located in front of the illumination panel.

5. The data obtaining device according to claim 1,
wherein the controller generates the mask data for the target on a basis of a differential image between a captured image at a time when the illumination panel is emitting light and a captured image at a time when the illumination panel is not emitting light.

6. The data obtaining device according to claim 1,
wherein the controller obtains a captured image without the target and the illumination panel illuminated by ambient light.

7. The data obtaining device according to claim 1,
wherein the controller sets luminance of the light emitted from the illumination panel such that luminance of the illumination panel becomes higher than luminance of the target in the at least one captured image.

8. The data obtaining device according to claim 1,
wherein the controller extracts, on a basis of the mask data for the target, image data regarding the target from an image of the target captured at a same position as when the at least one captured image has been captured.

9. The data obtaining device according to claim 8,
wherein the controller controls illumination light that illuminates the target.

10. A data obtaining method comprising:
causing an illumination panel to emit light; and
generating mask data for a target located in front of the illumination panel on a basis of a captured image of the target and the illumination panel.

11. The data obtaining method according to claim 10, further comprising:
extracting, on a basis of the mask data for the target, image data regarding the target from an image of the target at a same position as when the at least one captured image has been captured.

12. A data obtaining stage comprising:
an illumination panel that emits light in certain colors; and
a light transmission member located between a target disposed in front of the illumination panel and the illumination panel.

13. The data obtaining stage according to claim 12, further comprising:
a darkroom storing the illumination panel and the light transmission member.

14. The data obtaining stage according to claim 12, further comprising:
a lighting device capable of illuminating the target.

15. The data obtaining stage according to claim 12,
wherein the illumination panel emits light in one of the certain colors.
